(19) United States
(12) Patent Application Publication
(10) Pub. No.: US 2007/0040669 A1
(43) Pub. Date: Feb. 22, 2007

(54) Communications device comprising a receiver for important information, method of transmitting such information, and transmitting system using such a method

(75) Inventor: Pierre-Hugues Boucher, Le Mans (FR)

Correspondence Address: PHILIPS INTELLECTUAL PROPERTY & STANDARDS, P.O. BOX 3001, BRIARCLIFF MANOR, NY, 10510, US

(73) Assignee: Koninkjike Phillips Electronics N.V.

(21) Appl. No.: 10/573,739

(22) PCT Filed: Sep. 17, 2004
(86) PCT No.: PCT/IB04/03039

§ 371 Date: Mar. 28, 2006

(30) Foreign Application Priority Data
Sep. 30, 2003 (FR) 0350612

(51) Int. Cl. G08B 1/08; H04Q 7/00

(52) U.S. Cl. 340/539.11

(57) ABSTRACT

The present communications device comprises a receiver for short messages from a sender who or which is likely to send an important message, in particular to alert users to an imminent danger. The arrangement comprises means (M1, M2) for establishing a connection of the short message type, means (12, 13) for making such important messages perceivable, means for indicating the reception of the messages to the user, and means for supplying the sender with an acknowledgement (M4) of the receipt of said message of importance when the terminal is capable of processing the urgency of the message. Other actions are also proposed when the terminal is not capable of processing the urgency of the message. Applicable to the sending out of alerting messages in the event of imminent danger.

### FIELD OF THE INVENTION

The invention relates to a communications device comprising a receiver for information coming from a sender who or which is likely to send an important message.

The invention also relates to a method of transmitting information of this kind and to a system in which a method of this kind is used.

The invention finds significant applications particularly in the field of hard-wired or cellular telephone networks in which the devices are mobile telephones or the like. Each of these mobiles comprises receivers for receiving information of varying kinds, and particularly written messages. Something which in fact happens is that important messages may be urgent messages which need to be sent out quickly and reliably to a group of users to warn them of an imminent danger or of some notification of an emergent nature (a call to all the doctors situated in a district which is defined for a cardiac emergency for example, to the volunteer mountain-rescue workers in a town, etc.).

### BACKGROUND OF THE INVENTION

It is known from patent document DE 201 07 725 U1 for such messages to be transmitted, but nothing is said regarding the way in which the information concerned is transmitted.

### SUMMARY OF THE INVENTION

The invention proposes a device of the kind mentioned in the opening paragraph in which steps are taken to allow such important messages to be received and processed.

A receiver of this kind is notable in that it comprises means for receiving said important messages, means for indicating their reception to the user, and means for supplying the sender with an acknowledgement of receipt of said message of importance when said indicating means have been put into operation.

Another object of the invention is to transmit such important messages while retaining compatibility with ETSI standard ES 201 912. The short messages transmitted in this way are familiarly termed SMS messages.

The method of transmitting important information which is handled by means of a device as above and which comes from a sender using a message-emitting center is notable in that it comprises the following steps of:

establishing a connection of the short message type,

sending a message from a short message center with an indication showing its importance,

receiving an acknowledgement of receipt coming from said device,

releasing the short-message type connection.

These and other aspects of the invention are apparent from and will be elucidated with reference to the non-limiting embodiments described hereinafter.

### BRIEF DESCRIPTION OF THE DRAWINGS

In the drawings:

FIG. 1 shows a transmission system in which the invention is put to beneficial use.

FIG. 2 elucidates the method of the invention that is put into practice in the system of FIG. 1.

### DESCRIPTION OF PREFERRED EMBODIMENTS

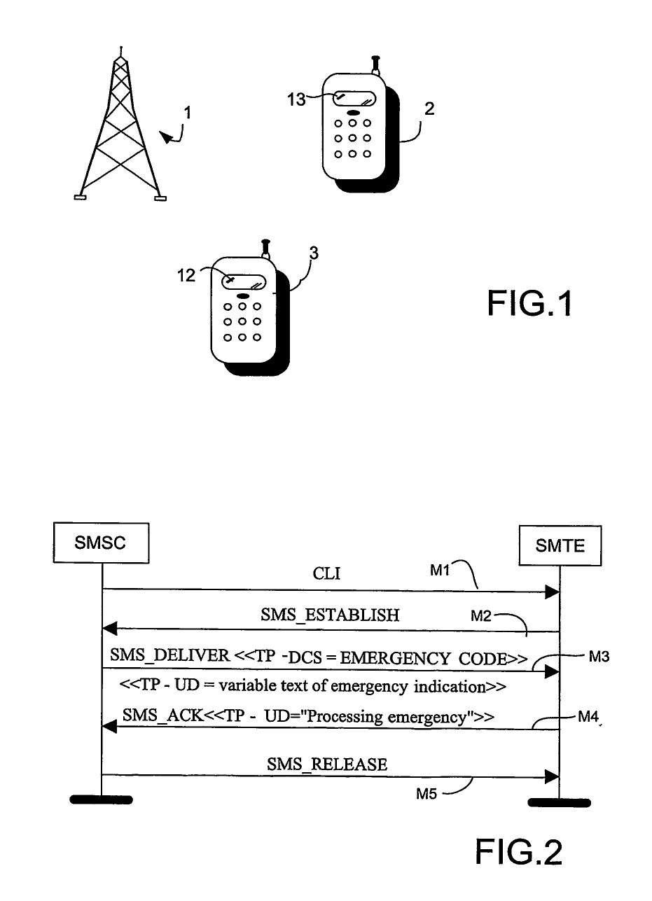

In FIG. 1 is shown a system according to the invention involving a cellular telephone network of the GSM type. What is shown is a base station 1 that is able to communicate with a plurality of mobile stations. In the Figure, only two of the latter are shown: mobile stations 2 and 3. The mobile stations 2 and 3 each have screens 12 and 13 respectively, such that messages of the SMS type can be displayed. These messages may also be perceivable by the user by listening to a synthetically generated voice, and may be indicated by for example a particular call tone, flashing LEDs, or alternating video reversal of the screen display The invention is applicable in an example of the following type. When municipal authorities are alerted to a probable flood in their area, they notify the people in the area of this by using messages of the SMS type as mentioned above. It goes without saying that it is important for a check to be made to see that the messages have in fact been received by their destination recipients. If they have not, it will then be necessary for other steps to be taken, such as sending out a vehicle fitted with a loudspeaker to warn the populace to whom the message of importance was addressed, or again operating sirens to alert the populace to the danger threatening them.

As dictated by the embodiments, the invention makes use of the possibilities provided by the above-mentioned standards. This is what is shown in FIG. 2.

In FIG. 2, the various messages presently concerned are exchanged between the SMSC (the Short Message Service center) and the SMTE (the item of Short Messaging Terminal Equipment, i.e. the mobile station that the user has). The first message M1 that is exchanged between the SMSC and the SMTE is an identifying message CL1. Then the connection for the SMSs (short messages) is established by means of message M2. The message center sends a message M3 of the emergency type. Conforming to the standards, the emergency nature is stated in field TP-DSC and the text of the message is specified in field TP-UD. When the terminal is capable of processing the emergency nature of the message by behaving in the appropriate way, a specific acknowledgement of receipt is emitted, namely message M4 that contains a TP-UD indicating that the terminal is processing the emergency, and finally the SMS connection is released by a message M5.

1. A communications device comprising a receiver for information coming from a sender who or which is likely to send an important message, characterized in that it comprises means for receiving said important messages, means for indicating their receipt to the user, and means for supplying the sender with an acknowledgement of the receipt of said message of importance when said indicating means have been put into operation.

2. A device as claimed in claim 1, characterized in that, in the event of the acknowledgement of receipt not being sent, an alerting message is sent back to enable the sender to envisage other actions.

3. A device as claimed in claim 1, characterized in that the message of importance is transmitted while retaining compatibility with ETSI standard ES 201 912.

4. A device as claimed in claim 3, characterized in that a code for message of importance is placed in a TP-DCS field.

5. A device as claimed in claim 3, characterized in that the text of the message of importance is placed in a TP-UD field.

6. A method of transmitting important information that is handled by means of a device as claimed in claim 1 and which comes from a sender using a message emitting center, characterized in that it comprises the following steps of:
establishing a connection of the short message type,
sending a message from a short message center with an indication showing its importance,
receiving an acknowledgement of receipt coming from said device,
releasing the short-message type connection.

7. A method as claimed in claim 6, characterized in that, in the event of an acknowledgement of receipt not being received, the sender is alerted so that he or it can take other actions.

8. A method as claimed in claim 6, characterized in that the messages are compatible with ETSI standard ES 201 912.

9. A system for transmitting important messages that uses the method claimed in claim 6, characterized in that it comprises a center for emitting important messages that is able to send out such a message to a plurality of users.
